(19) United States
(12) Patent Application Publication
(10) Pub. No.: US 2026/0169192 A1
(43) Pub. Date: Jun. 18, 2026

(54) MONOFUNCTIONAL UREA-BASED ORGANOSILICON MONOMERS AND SILICONE HYDROGELS FORMED THEREFROM

(71) Applicant: Bausch + Lomb Ireland Limited, Dublin (IE)

(72) Inventors: Jamie Homnick, Webster, NY (US); Yongxing Qiu, Rochester, NY (US)

(21) Appl. No.: 19/421,386

(22) Filed: Dec. 16, 2025

Related U.S. Application Data
(60) Provisional application No. 63/734,905, filed on Dec. 17, 2024.

(51) Int. Cl. G02B 1/04; B29D 11/00; B29K 33/00; B29K 105/00; C07F 7/08

(52) U.S. Cl. CPC G02B 1/043; B29D 11/00134; C07F 7/0838; B29K 2033/26; B29K 2105/0002; B29K 2105/0085

(57) ABSTRACT

A monofunctional urea-based organosilicon monomer represented by a structure of Formula I:

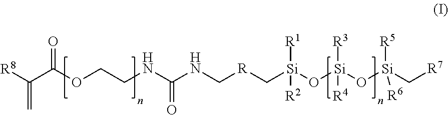

wherein R, R¹, R², R³, R⁴, R⁵, R⁶, R⁷, R⁸, m and n are as defined herein. An ophthalmic device having optical clarity is a polymerization product of a monomeric mixture including (a) one or more monofunctional urea-based organosilicon monomers represented by a structure of Formula I, and (b) one or more ophthalmic device-forming hydrophilic comonomers or polymers.

### PRIORITY CLAIM

The present application claims priority to U.S. Provisional Patent Application Ser. No. 63/734,905, entitled “Multifunctional Urea-Based Organosilicon Monomers and Silicone Hydrogels Formed Therefrom,” filed Dec. 17, 2024, the content of which is incorporated by reference herein in its entirety.

### BACKGROUND

In the field of biomedical devices such as contact lenses, various physical and chemical properties such as, for example, optical clarity, oxygen permeability, wettability, material strength and stability are but a few of the factors that must be carefully balanced in order to provide a useable contact lens. For example, since the cornea receives its oxygen supply exclusively from contact with the atmosphere, good oxygen permeability is a critical characteristic for any contact lens material. Wettability also is important in that, if the lens is not sufficiently wettable, it does not remain lubricated and therefore cannot be worn comfortably in the eye. Accordingly, the optimum contact lens would have at least both excellent oxygen permeability and excellent tear fluid wettability.

Hydrogels represent a desirable class of materials for many biomedical applications, including contact lenses and intraocular lenses. Hydrogels are hydrated, cross-linked polymeric systems that contain water in an equilibrium state. Silicone hydrogels are a known class of hydrogels and are characterized by the inclusion of a silicone-containing material. Typically, a silicone-containing monomer is copolymerized by free radical polymerization with a hydrophilic monomer, with either the silicone-containing monomer or the hydrophilic monomer functioning as a crosslinking agent (a crosslinker being defined as a monomer having multiple polymerizable functionalities) or a separate crosslinker may be employed. An advantage of silicone hydrogels over non-silicone hydrogels is that the silicone hydrogels typically have higher oxygen permeability due to the inclusion of the silicone-containing monomer.

### SUMMARY

In accordance with an aspect of the present disclosure, a monofunctional urea-based organosilicon monomer is represented by a structure of Formula I:

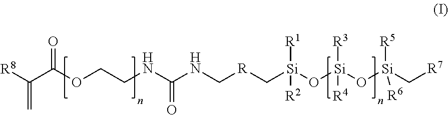

wherein R, R¹, R², R³, R⁴, R⁵, R⁶, R⁷, R⁸, m and n are as defined herein.

In accordance with another illustrative embodiment, an ophthalmic device comprising a polymerization product of a monomeric mixture comprises:
(a) one or more monofunctional urea-based organosilicon monomers represented by a structure of Formula I:

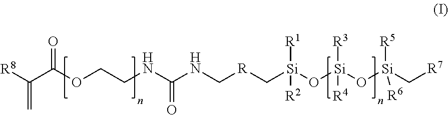

wherein R, R¹, R², R³, R⁴, R⁵, R⁶, R⁷, R⁸, m and n are as defined herein, and
(b) one or more ophthalmic device-forming hydrophilic comonomers or polymers.

In accordance with another aspect of the present disclosure, a method for making an ophthalmic device comprises:
(a) curing in a mold a polymerization product of a monomeric mixture comprising:
(i) one or more monofunctional urea-based organosilicon monomers represented by a structure of Formula I:

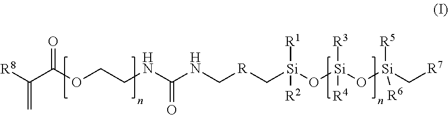

wherein R, R¹, R², R³, R⁴, R⁵, R⁶, R⁷, R⁸, m and n are as defined herein, and
(ii) one or more ophthalmic device-forming hydrophilic comonomers or polymers, and
(b) dry releasing the polymerization product from the mold.

### DETAILED DESCRIPTION

Various illustrative embodiments described herein are directed to monofunctional urea-based organosilicon monomers and their use in forming ophthalmic devices such as silicon hydrogels having improved optical clarity.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

As used herein, the term “SiHy” shall be understood to mean silicone hydrogel.

As used herein, the term “hydrogel” or “hydrogel material” refers to a crosslinked polymeric material that has three-dimensional polymer networks (i.e., polymer matrix), is insoluble in water, but can hold at least 10 percent by weight of water in its polymer matrix when it is fully hydrated.

As used herein, the term “silicone hydrogel” or “SiHy” interchangeably refers to a hydrogel containing silicone. A silicone hydrogel (SiHy) typically is obtained by copolymerization of a polymerizable composition comprising at least one silicone-containing vinylic monomer or at least one silicone-containing vinylic macromer or at least one silicone-containing prepolymer having ethylenically unsaturated groups.

As used herein, the term “ophthalmic device” refers to ophthalmic devices that reside in or on the eye. These devices can provide optical correction, wound care, drug delivery, diagnostic functionality or cosmetic enhancement or effect or a combination of these properties. Suitable ophthalmic devices include, for example, ophthalmic lenses such as soft contact lenses, e.g., a soft, hydrogel lens; soft, non-hydrogel lens and the like, hard contact lenses, e.g., a hard, gas permeable lens material and the like, intraocular lenses, overlay lenses, ocular inserts, optical inserts and the like. As is understood by one skilled in the art, a lens is considered to be “soft” if it can be folded back upon itself without breaking.

As used herein, the term “(meth)” denotes an optional methyl substituent. Thus, terms such as “(meth)acrylate” denotes either methacrylate or acrylate, and “(meth)acrylamide” denotes either methacrylamide or acrylamide.

As used in this disclosure, the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means 20% of the stated value, ±15% of the stated value, ±10% of the stated value, ±5% of the stated value, ±3% of the stated value, or 1% of the stated value.

The terms “wt. %,” “vol. %” or “mol. %” refers to a weight, volume, or molar percentage of a component, respectively, based on the total weight, the total volume, or the total moles of material that includes the component. In a non-limiting example, 10 moles of component in 100 moles of the material are 10 mol. % of component.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

Silicone hydrogels (SiHy) such as contact lenses, which are made of a hydrated, crosslinked polymeric material that contains silicone and a certain amount of water within the lens polymer matrix at equilibrium, are increasingly becoming popular, because they have minimal adverse effects on corneal health due to their high oxygen permeability. However, incorporation of silicone in a contact lens material can have undesirable effects on the hydrophilicity and wettability of silicone hydrogels, because silicone is hydrophobic and has a great tendency to migrate onto the lens surface being exposed to air. Contact lens manufacturers have therefore made a great effort in developing SiHy contact lenses having a hydrophilic and wettable surface.

The illustrative embodiments described herein overcome the foregoing drawbacks by using one or more of the monofunctional urea-based organosilicon monomers represented by the structure of Formula I to form an ophthalmic device such as a SiHy contact lens having improved properties directed to, for example, hydrophilicity and wettability. In addition, the one or more monofunctional urea-based organosilicon monomers represented by the structure of Formula I are compatible with the ophthalmic device-forming monomers in the monomeric mixtures to form optically clear contact lenses.

In accordance with non-limiting illustrative embodiments, a monofunctional silicone monomer for use in forming the ophthalmic devices described herein is represented by a structure of Formula I:

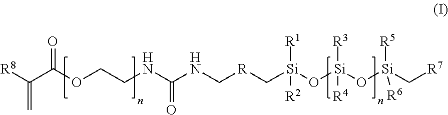

wherein R is an alkylene group, R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group, R⁸ is hydrogen or methyl, m is at least 1 and n is at least 1.

In some embodiments, R is a C₁ to C₆ alkylene group, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group, R⁸ is hydrogen or methyl, m is 1 to 20 and n is from 1 to 12.

In some embodiments, R is a C₁ to C₆ alkylene group, R¹, R², R³ and R⁴ are independently hydrogen, or a C₁ to C₆ alkyl group; R⁵, R⁶ and R⁷ are independently a straight or branched C₁ to C₆ alkyl group, R⁸ is hydrogen or methyl, m is from 5 to 15, and n is from 1 to 3.

In some embodiments, R is a C₁ to C₆ alkylene group, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group, R⁸ is hydrogen or methyl, m is from 5 to 15; and n is from 1 to 3.

Representative examples of alkyl groups for use herein include, by way of example, a straight or branched alkyl chain radical containing carbon and hydrogen atoms of from 1 to about 30 carbon atoms or from 1 to about 12 carbon atoms or from 1 to about 6 carbon atoms or from 1 to about 3 carbon atoms with or without unsaturation, to the rest of the molecule, e.g., methyl, ethyl, n-propyl, 1-methylethyl (isopropyl), n-butyl, n-pentyl, methylene, ethylene, etc., and the like, optionally containing one or more heteroatoms, e.g., O and N, and the like, or one or more halogen atoms, e.g., fluorine, chlorine, bromine, and iodine, to form a halo alkyl group.

Representative examples of cycloalkyl groups for use herein include, by way of example, a substituted or unsubstituted, non-aromatic mono or multicyclic ring system of about 3 to about 30 carbon atoms or from 3 to about 12 carbon atoms or from 3 to about 6 carbon atoms such as, for example, cyclopropyl, cyclobutyl, cyclopentyl, cyclohexyl, perhydronapththyl, adamantyl and norbornyl groups, bridged cyclic groups or sprirobicyclic groups, e.g., spiro-(4, 4)-non-2-yl and the like, optionally containing one or more heteroatoms, e.g., O and N, and the like to form a heterocycloalkyl group.

Representative examples of cycloalkylalkyl groups for use herein include, by way of example, a substituted or unsubstituted, cyclic ring-containing radical containing from about 4 to about 30 carbon atoms or from 3 to about 6 carbon atoms directly attached to the alkyl group which are then attached to the main structure of the monomer at any carbon from the alkyl group that results in the creation of a stable structure such as, for example, cyclopropylmethyl, cyclobutylethyl, cyclopentylethyl and the like, wherein the cyclic ring can optionally contain one or more heteroatoms, e.g., O and N, and the like to form a heterocycloalkylalkyl group.

Representative examples of cycloalkenyl groups for use herein include, by way of example, a substituted or unsubstituted cyclic ring-containing radical containing from about 3 to about 30 carbon atoms or from 3 to about 6 carbon atoms with at least one carbon-carbon double bond such as, for example, cyclopropenyl, cyclobutenyl, cyclopentenyl and the like, wherein the cyclic ring can optionally contain one or more heteroatoms, e.g., O and N, and the like to form a heterocycloalkenyl group.

Representative examples of aryl groups for use herein include, by way of example, a substituted or unsubstituted, monoaromatic or polyaromatic radical containing from about 6 to about 30 carbon atoms or from about 6 to about 12 carbon atoms such as, for example, phenyl, naphthyl, tetrahydronapthyl, indenyl, biphenyl and the like, optionally containing one or more heteroatoms, e.g., O and N, and the like to form a heteroaryl group.

In an illustrative embodiment, the monofunctional urea-based organosilicon monomer represented by the structure of Formula I disclosed herein can be prepared based on the known reaction between an isocyanate group and an amino group to form a urea linkage. For example, an isocyanate-containing acrylate (or methacrylate) can react with an aminoalkyl polysiloxane monomer to form a monofunctional urea-based organosilicon monomer of Formula I.

Suitable isocyanatoalkylacrylates and isocyanatoalkylmethacrylates include, for example, isocyanatomethylacrylate, isocyanatoethylacrylate, isocyanatopropylacrylate, isocyanatoisopropylacrylate, isocyanatobutylacrylate, isocyanatopentylacrylate, isocyanatohexylylacrylate, isocyanatoheptylacrylate, isocyanatomethylmethacrylate, isocyanatoethylmethacrylate, isocyanatopropylmethacrylate, isocyanatoisopropylmethacrylate, isocyanatobutylmethacrylate, isocyanatopentylmethacrylate, isocyanatohexylmethacrylate, and isocyanatoheptylmethacrylate. Suitable aminoalkyl-tris(trimethylsiloxy) silanes include, for example, aminoethyl-tris(trimethylsiloxy) silane, aminopropyl-tris(trimethylsiloxy) silane, aminobutyl-tris(trimethylsiloxy) silane, aminopentyl-tris(trimethylsiloxy) silane, aminohexyl-tris(trimethylsiloxy) silane, and aminoheptyl-tris(trimethylsiloxy) silane.

Suitable aminoalkyl polysiloxane monomers include, for example, mono-aminoethyl terminated polydimethylsiloxane, mono-aminopropyl terminated polydimethylsiloxane and the like.

As stated above, the monofunctional urea-based organosilicon monomers represented by a structure of Formula I disclosed herein are useful in forming ophthalmic devices having improved optical clarity. The ophthalmic device disclosed herein is a polymerization product of a monomeric mixture which comprises:
(a) one or more of the monofunctional urea-based organosilicon monomers represented by a structure of Formula I:

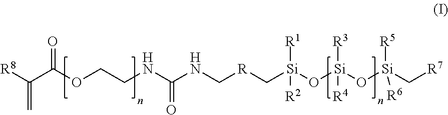

wherein R, R¹, R², R³, R⁴, R¹, R⁶, R⁷, R⁸, m and n are as defined herein; and
(b) one or more ophthalmic device-forming hydrophilic comonomers or polymers.

In some embodiments, the monomeric mixture can include the one or more monofunctional urea-based organosilicon monomers represented by a structure of Formula I in an amount ranging from about 1 wt. % to about 50 wt. %, based on the total weight of the monomeric mixture. In some embodiments, the monomeric mixture can include the one or more monofunctional urea-based organosilicon monomers represented by a structure of Formula I in an amount ranging from about 10 wt. % to about 40 wt. %, based on the total weight of the monomeric mixture.

Suitable ophthalmic device-forming hydrophilic comonomers or polymers as component (b) include, for example, unsaturated carboxylic acids, acrylamides, vinyl lactams, hydroxyl-containing-(meth)acrylates, hydrophilic vinyl carbonates, hydrophilic vinyl carbamates, hydrophilic oxazolones, and poly(alkene glycols) functionalized with polymerizable groups and the like and mixtures thereof. Representative examples of unsaturated carboxylic acids include, but are not limited to, methacrylic acid, acrylic acid and the like and mixtures thereof. Representative examples of acrylamides include, but are not limited to, alkylamides such as N,N-dimethylacrylamide, N,N-dimethylmethacrylamide and the like and mixtures thereof. Representative examples of cyclic lactams include, but are not limited to, N-vinyl-2-pyrrolidone, N-vinyl caprolactam, N-vinyl-2-piperidone and the like and mixtures thereof. Representative examples of hydroxyl-containing (meth)acrylates include, but are not limited to, 2-hydroxyethyl methacrylate (HEMA), 2-hydroxyethyl acrylate (HEA), glycerol methacrylate and the like and mixtures thereof. Additional ophthalmic device-forming hydrophilic comonomers or polymers include, for example, the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable ophthalmic device-forming hydrophilic comonomers or polymers will be apparent to one skilled in the art. Mixtures of the foregoing ophthalmic device-forming hydrophilic comonomers or polymers can also be used in the monomeric mixtures herein.

In some embodiments, the ophthalmic device-forming hydrophilic comonomers or polymers as component (b) include one or more hydrophilic acrylate or acrylamide comonomers. Suitable one or more hydrophilic acrylate or acrylamide comonomers include, for example, alkylamides such as N,N-dimethylacrylamide, N,N-dimethylmethacrylamide and the like, hydroxyl-containing acrylates such as 2-hydroxyethyl acrylate (HEA) and the like and mixtures thereof.

In some embodiments, the monomeric mixture can include the one or more ophthalmic device-forming hydrophilic comonomers or polymers in an amount ranging from about 50 wt. % to about 90 wt. %, based on the total weight of the monomeric mixture. In some embodiments, the monomeric mixture can include the one or more ophthalmic device-forming hydrophilic comonomers or polymers in an amount ranging from about 60 wt. % to about 90 wt. %, based on the total weight of the monomeric mixture.

The monomeric mixture can further include one or more ophthalmic device-forming silicone comonomers. In an illustrative embodiment, as may be combined with one or more of the preceding paragraphs, the one or more ophthalmic device-forming silicone comonomers can include, as a class of representative ophthalmic device-forming silicone comonomers, one or more monofunctional urea-based silicone monomers represented by a structure of Formula II:

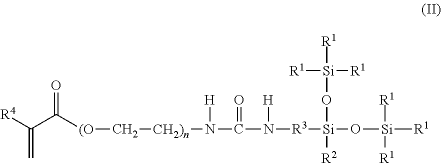

wherein each R¹ is independently an alkyl group; R² is an alkyl group or a trialkyl siloxy group, R³ is an alkylene group, R⁴ is hydrogen or methyl and n is an integer from 1 to 12.

In some embodiments, R¹ and R² are independently a C₁ to C₆ alkyl group; R³ is a C₁ to C₆ alkylene group; and n is from 1 to 3.

In some embodiments, R¹ and R² are independently a C₁ to C₃ alkyl group; R³ is a C₁ to C₃ alkylene group; and n is from 1 to 3.

In some embodiments, R¹ and R² are independently a C₁ to C₃ alkyl group; R³ is a C₁ to C₃ alkylene group; and n is from 3 to 5.

In some embodiments, R¹ is a C₁ to C₆ alkyl group; R² is a tri C₁ to C₆ alkyl siloxy group, R³ is a C₁ to C₆ alkylene group; and n is from 1 to 3.

In some embodiments, R¹ is a C₁ to C₃ alkyl group; R² is a tri C₁ to C₃ alkyl siloxy group, R³ is a C₁ to C₃ alkylene group; and n is from 1 to 3.

In some embodiments, R¹ is a C₁ to C₃ alkyl group; R² is a tri C₁ to C₃ alkyl siloxy group, R³ is a C₁ to C₃ alkylene group; and n is from 3 to 5.

In an illustrative embodiment, the monofunctional urea-based silicone monomer represented by the structure of Formula II disclosed herein can be prepared based on the known reaction between an isocyanate group and an amino group to form a urea linkage. For example, an isocyanate-containing acrylate (or methacrylate) can react with an aminoalkyl-tris(trialkylsiloxy) silane or an aminoalkyl-bis(trialkylsiloxy)alkyl silane to form a vinylic monomer of Formula II.

Suitable isocyanatoalkylacrylates and isocyanatoalkylmethacrylates include, for example, isocyanatomethylacrylate, isocyanatoethylacrylate, isocyanatopropylacrylate, isocyanatoisopropylacrylate, isocyanatobutylacrylate, isocyanatopentylacrylate, isocyanatohexylylacrylate, isocyanatoheptylacrylate, isocyanatomethylmethacrylate, isocyanatoethylmethacrylate, isocyanatopropylmethacrylate, isocyanatoisopropylmethacrylate, isocyanatobutylmethacrylate, isocyanatopentylmethacrylate, isocyanatohexylmethacrylate, and isocyanatoheptylmethacrylate. Suitable aminoalkyl-tris(trimethylsiloxy) silanes include, for example, aminoethyl-tris(trimethylsiloxy) silane, aminopropyl-tris(trimethylsiloxy) silane, aminobutyl-tris(trimethylsiloxy) silane, aminopentyl-tris(trimethylsiloxy) silane, aminohexyl-tris(trimethylsiloxy) silane, and aminoheptyl-tris(trimethylsiloxy) silane.

Suitable aminoalkyl-bis(trialkylsiloxy)alkyl silanes include, for example, aminoethylmethyl-bis(trimethylsiloxy) silane, aminopropylmethyl-bis(trimethylsiloxy) silane, aminobutylmethyl-bis(trimethylsiloxy) silane, aminopentylmethyl-bis(trimethylsiloxy) silane, aminohexylmethyl-bis(trimethylsiloxy) silane, and aminoheptylmethyl-bis(trimethylsiloxy) silane.

In some embodiments, the monomeric mixture can include the one or more monofunctional urea-based silicone monomers represented by a structure of Formula II in an amount ranging from about 1 wt. % to about 50 wt. %, based on the total weight of the monomeric mixture. In some embodiments, the monomeric mixture can include the one or more monofunctional urea-based silicone monomers represented by a structure of Formula II in an amount ranging from about 10 wt. % to about 40 wt. %, based on the total weight of the monomeric mixture.

The one or more ophthalmic device-forming silicone comonomers can include, as a class of representative ophthalmic device-forming silicone comonomers, one or more non-bulky organosilicon-containing monomers. An “organosilicon-containing monomer” as used herein contains at least one [siloxanyl] or at least one [silyl-alkyl-siloxanyl]repeating unit, in a monomer, macromer or prepolymer. In an illustrative embodiment, an example of a non-bulky organosilicon-containing monomers is represented by a structure of Formula IIIa:

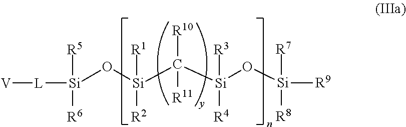

wherein V is an ethylenically unsaturated polymerizable group, L is a linking group or a bond; R¹, R², R³, R⁴, R⁵, R⁶, R⁷, R⁸, and R⁹ are independently hydrogen, an alkyl group, a haloalkyl group, a cycloalkyl group, a heterocycloalkyl group, an alkenyl group, a halo alkenyl group, or an aryl group; R¹⁰ and R¹¹ are independently hydrogen or an alkyl group wherein at least one of R¹⁰ and R¹¹ is hydrogen; y is 2 to 7 and n is 1 to 100 or from 1 to 20.

Ethylenically unsaturated polymerizable groups are well known to those skilled in the art. Suitable ethylenically unsaturated polymerizable groups include, for example, (meth)acrylates, vinyl carbonates, O-vinyl carbamates, N-vinyl carbamates, and (meth)acrylamides.

Linking groups can be any divalent radical or moiety and include, for example, substituted or unsubstituted C₁ to C₁₂ alkyl group, an alkyl ether group, an alkenyl group, an alkenyl ether group, a halo alkyl group, a substituted or unsubstituted siloxane group, and monomers capable of propagating ring opening.

In some embodiments, V is a (meth)acrylate, L is a C₁ to C₁₂ alkylene group, R¹, R², R³, R⁴, R⁵, R⁶, R⁷, R⁸, and R⁹ are independently a C₁ to C₁₂ alkyl group, R¹⁰ and R¹¹ are independently H or a C₁ to C₁₂ alkyl group, y is 2 to 7 and n is 3 to 8.

In some embodiments, V is a (meth)acrylate, L is a C₁ to C₆ alkyl group, R¹, R², R³, R⁴, R⁵, R⁶, R⁷, R⁸, and R⁹ are independently a C₁ to C₆ alkyl group, R¹⁰ and R¹¹ are independently H or a C₁ to C₆ alkyl group, y is 2 to 7 and n is 1 to 20.

Non-bulky organosilicon-containing monomers represented by a structure of Formula IIIa are known in the art, see, e.g., U.S. Pat. Nos. 7,915,323, 7,994,356, 8,420,711, 8,827,447 and 9,039,174, the contents of which are incorporated by reference herein.

In an illustrative embodiment, as may be combined with one or more of the preceding paragraphs, the one or more non-bulky organosilicon-containing monomers can also comprise a compound represented by a structure of Formula IIIb:

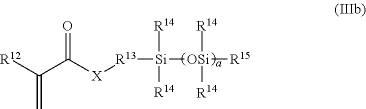

wherein R¹² is H or methyl; X is O or NR¹⁶; wherein R¹⁶ is selected from H, or C₁ to C₄ alkyl, which may be further substituted with one or more hydroxyl groups, and in some embodiments is H or methyl; R¹³ is a divalent alkyl group, which may further be functionalized with a group selected from the group consisting of ether groups, hydroxyl groups, carbamate groups and combinations thereof, and in another embodiment a C₁ to C₆ alkylene group which may be substituted with ether, hydroxyl and combinations thereof, and in yet another embodiment a C₁ or C₃ to C₄ alkylene group which may be substituted with ether, hydroxyl and combinations thereof, each R¹⁴ is independently a phenyl or a C₁ to C₄ alkyl group which may be substituted with fluorine, hydroxyl or ether, and in another embodiment each R¹⁴ is independently selected from ethyl and methyl groups, and in yet another embodiment, each R¹⁴ is methyl; R¹⁵ is a C₁ to C₄ alkyl group; a is 2 to 50, and in some embodiments 5 to 15.

Non-bulky organosilicon-containing monomers represented by a structure of Formula IIIb are known in the art, see, e.g., U.S. Pat. Nos. 8,703,891, 8,937,110, 8,937,111, 9,156,934 and 9,244,197, the contents of which are incorporated by reference herein.

Representative examples of the non-bulky organosilicon-containing monomers include:

M1EDS6: a compound having the structure and available from Gelest:

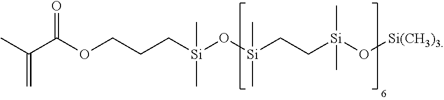

MCR-M11: a compound having the structure:

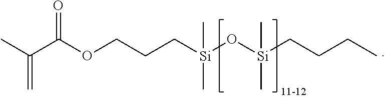

M1-MCR-C12: a compound having the structure:

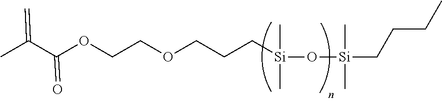

wherein n is an average of 12.

The one or more ophthalmic device-forming silicone comonomers can include, as a class of representative ophthalmic device-forming silicone comonomers, one or more polysiloxane prepolymers represented by a structure of Formula IV:

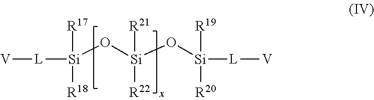

wherein each V is an independently reactive functional end group and includes, by way of example, a hydroxyl-containing reactive functional end group, and an amine-containing reactive functional end group, R¹⁷ to R²² are independently straight or branched, substituted or unsubstituted C₁-C₃₀ alkyl group, a substituted or unsubstituted C₃-C₃₀ cycloalkyl group, a substituted or unsubstituted C₄-C₃₀ cycloalkylalkyl group, a substituted or unsubstituted C₃-C₃₀ cycloalkenyl group, a substituted or unsubstituted C₆-C₃₀ aryl group, and a substituted or unsubstituted C₇-C₃₀ arylalkyl group, and L is independently a linking group.

A hydroxyl-containing reactive functional end group for use herein is a group of the general Formula —OH. Representative examples of amine-containing reactive functional end groups for use herein include, by way of example, a (meth)acrylamide-containing reactive functional end group.

Linking group L is independently a straight or branched alkyl group, cycloalkyl group, an aryl group, an ether or polyether group, and an ester group as defined herein.

A representative example of a polysiloxane prepolymer is as follows:

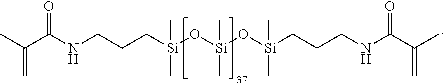

Methods for making the polysiloxane prepolymers described herein are well known and within the purview of one skilled in the art. In addition, the polysiloxane prepolymers are also commercially available from such sources as, for example, Gelest, Silar, Shin-Etsu, Momentive and Siltech.

The one or more ophthalmic device-forming silicone comonomers can include, as a class of representative ophthalmic device-forming silicone comonomers, one or more bulky siloxane-containing monomers. The term “bulky” refers to groups on the siloxane monomer that are sterically and/or electronically encumbering, i.e., sterically hindering. In an embodiment, suitable bulky siloxane-containing monomers include, for example, a bulky polysiloxanylalkyl (meth)acrylic monomer, a bulky polysiloxanylalkyl carbamate monomer and mixtures thereof. A representative example of a bulky siloxane-containing monomer includes a bulky siloxane-containing monomer represented by a structure of Formula V:

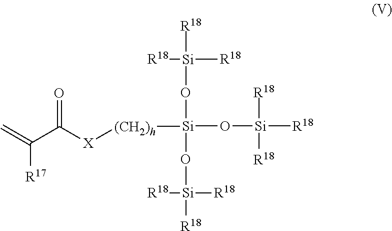

wherein X denotes —O— or —NR¹⁹—, where each R¹⁹ is hydrogen or a C₁-C₄ alkyl group; R¹⁷ independently denotes hydrogen or methyl; each R¹⁸ independently denotes a lower alkyl radical such as a C₁-C₆ group, a phenyl radical or a group represented by the following structure:

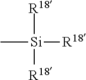

wherein each R^{18′} independently denotes a lower alkyl radical or a phenyl radical; and h is 1 to 10; or a bulky siloxane-containing monomer represented by a structure of Formula VI:

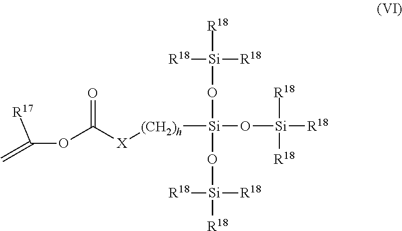

wherein X denotes —NR¹⁹— wherein R¹⁹ denotes hydrogen or a C₁-C₄ alkyl; R¹⁷ denotes hydrogen or methyl; each R¹⁸ independently denotes a lower alkyl radical, a phenyl radical or a group represented by the following structure:

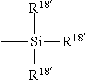

wherein each R^{18′} independently denotes a lower alkyl radical or a phenyl radical; and h is 1 to 10.

Representative examples of bulky siloxane-containing monomers include 3-methacryloyloxypropyltris(trimethylsiloxy)silane or tris(trimethylsiloxy)silylpropyl methacrylate, sometimes referred to as TRIS, tris(trimethylsiloxy)silylpropyl vinyl carbamate, sometimes referred to as TRIS-VC, pentamethyldisiloxanyl methylmethacrylate, phenyltetramethyl-disiloxanylethyl acetate, and methyldi(trimethylsiloxy)methacryloxymethyl silane, (3-methacryloxy-2-hydroxy propoxy)propyl bis(trimethyl siloxy)methyl silane, sometimes referred to as Sigma and the like and mixtures thereof. In some embodiments, the bulky siloxane-containing monomer is a tris(trialkylsiloxy)silylalkyl methacrylate-containing monomer such as a tris(trimethylsiloxy)silylpropyl methacrylate-containing monomer.

Such bulky siloxane-containing monomers may be copolymerized with a silicone macromonomer, which is a poly(organosiloxane) capped with an unsaturated group at two or more ends of the molecule. U.S. Pat. No. 4,153,641 discloses, for example, various unsaturated groups such as acryloxy or methacryloxy groups.

The one or more ophthalmic device-forming silicone comonomers can include, as a class of representative ophthalmic device-forming silicone comonomers, one or more silicone-containing vinyl carbonate or vinyl carbamate monomers. Suitable one or more silicone-containing vinyl carbonate or vinyl carbamate monomers include, for example, 1,3-bis[4-vinyloxycarbonyloxy)but-1-yl]tetramethyl-disiloxane; 3-(trimethylsilyl)propyl vinyl carbonate; 3-(vinyloxycarbonylthio)propyl-[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; trimethylsilylmethyl vinyl carbonate and the like and mixtures thereof.

The one or more ophthalmic device-forming silicone comonomers can include, as a class of representative ophthalmic device-forming silicone comonomers, one or more polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacrylates in Polyurethane-Polysiloxane Hydrogels,” Journal of Applied Polymer Science, Vol. 60, 1193-1199 (1996). PCT Published Application No. WO 96/31792 discloses examples of such monomers, which disclosure is hereby incorporated by reference in its entirety. Further examples of silicone urethane monomers are represented by Formulae VII and VIII:

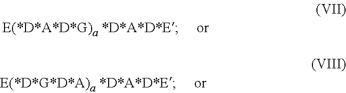

wherein:
D independently denotes an alkyl diradical, an alkyl cycloalkyl diradical, a cycloalkyl diradical, an aryl diradical or an alkylaryl diradical having 6 to about 30 carbon atoms;
G independently denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;
* denotes a urethane or ureido linkage;
a is at least 1;

A independently denotes a divalent polymeric radical of Formula IX:

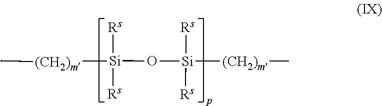

wherein each R^{s} independently denotes an alkyl or fluoro-substituted alkyl group having 1 to about 10 carbon atoms which may contain ether linkages between the carbon atoms; m′ is at least 1; and p is a number that provides a moiety weight of about 400 to about 10,000;

each of E and E′ independently denotes a polymerizable unsaturated organic radical represented by Formula IX:

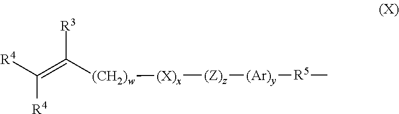

wherein: R³ is hydrogen or methyl;
R⁴ is hydrogen, an alkyl radical having 1 to 6 carbon atoms, or a —CO—Y—R⁶ radical wherein
Y is —O—, —S— or —NH—;
R⁵ is a divalent alkylene radical having 1 to about 10 carbon atoms;
R⁶ is a alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

The one or more ophthalmic device-forming silicone comonomers can include, as a class of representative ophthalmic device-forming silicone comonomers, one or more silicone-containing urethane monomers represented by Formula XI:

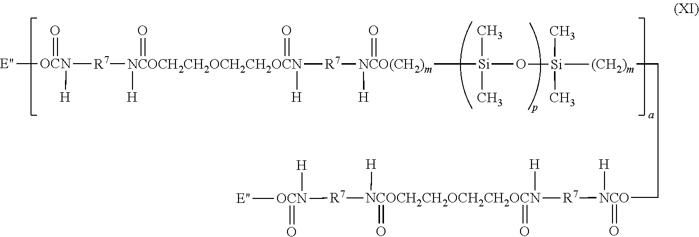

wherein m is at least 1 and is preferably 3 or 4, a is at least 1 and preferably is 1, p is a number which provides a moiety weight of about 400 to about 10,000 and is preferably at least about 30, R⁷ is a diradical of a diisocyanate after removal of the isocyanate group, such as the diradical of isophorone diisocyanate, and each E″ is a group represented by:

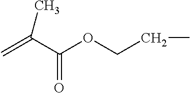

In another embodiment, a silicone hydrogel material comprises (in bulk, that is, in the monomeric mixture that is copolymerized) about 5 to about 50 percent, or from about 10 to about 25 percent, by weight of one or more silicone macromonomers, about 5 to about 75 percent, or about 30 to about 60 percent, by weight of one or more polysiloxanylalkyl (meth)acrylic monomers, and about 10 to about 50 percent, or about 20 to about 40 percent, by weight of a hydrophilic monomer. In general, the silicone macromonomer is a poly(organosiloxane) capped with an unsaturated group at two or more ends of the molecule. In addition to the end groups in the above structural Formulas, U.S. Pat. No. 4,153,641 discloses additional unsaturated groups, including acryloxy or methacryloxy. Fumarate-containing materials such as those disclosed in U.S. Pat. Nos. 5,310,779; 5,449,729 and 5,512,205 are also useful substrates in accordance with the non-limiting embodiments described herein. The silane macromonomer may be a silicone-containing vinyl carbonate or vinyl carbamate or a polyurethane-polysiloxane having one or more hard-soft-hard blocks and end-capped with a hydrophilic monomer.

The one or more ophthalmic device-forming silicone comonomers can include, as a class of representative ophthalmic device-forming silicone comonomers, one or more monomers of Formula XII:

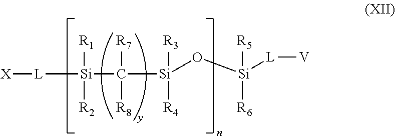

wherein X is the residue of a ring opening agent; L is the same or different and is a linking group or a bond; V is an ethylenically unsaturated polymerizable group; R₁, R₂, R₃, R₄, R₅, R₆ are independently hydrogen, an alkyl group, a haloalkyl group, a cycloalkyl group, a heterocycloalkyl group, an alkenyl group, a halo alkenyl group, or an aromatic group; R₇ and R₈ are independently hydrogen or an alkyl group wherein at least one of R₇ or R₈ is hydrogen; y is 2-7 and n is 1-100.

Ring opening agents are well known in the literature. Non-limiting examples of anionic ring opening agents include alkyl lithium, an alkoxide, trialkylsiloxylithium wherein the alkyl group may or may not contain halo atoms.

Linking groups can be any divalent radical or moiety and include substituted or unsubstituted alkyl, alkyl ether, alkenyls, alkenyl ethers, halo alkyls, substituted or unsubstituted siloxanes, and monomers capable of propagating ring opening.

Ethylenically unsaturated polymerizable groups are well known to those skilled in the art. Non-limiting examples of ethylenically unsaturated polymerizable groups would include acrylates, methacrylates, vinyl carbonates, O-vinyl carbamates, N-vinyl carbamates, acrylamides and methacrylamides.

The one or more ophthalmic device-forming silicone comonomers can include, as a class of representative ophthalmic device-forming silicone comonomers, one or more monomers of Formula XIII:

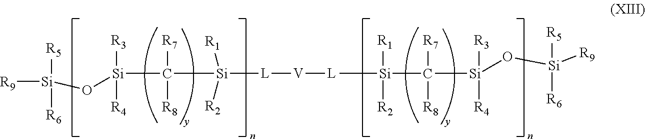

wherein L is the same or different and is a linking group or a bond; V is the same or different and is an ethylenically unsaturated polymerizable group; R₁, R₂, R₃, R₄, R₅, R₆ and R₉ are independently hydrogen, an alkyl group, a haloalkyl group, a cycloalkyl group, a heterocycloalkyl group, an alkenyl group, a halo alkenyl group, or an aromatic group; R₇ and R₈ are independently hydrogen or an alkyl group wherein at least one of R₇ or R₈ is hydrogen; y is 2-7 and n is 1-100.

The one or more ophthalmic device-forming silicone comonomers can include, as a class of representative ophthalmic device-forming silicone comonomers, one or more monomers of Formulae XIV and XV:

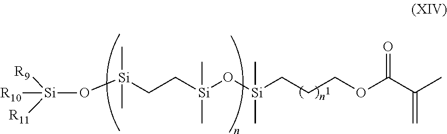

wherein R₉, R₁₀ and R₁₁ are independently hydrogen, an alkyl group, a haloalkyl group or other substituted alkyl groups; n is as defined above and n¹ is 0-10; and,

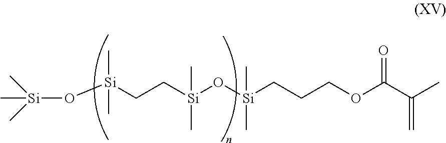

wherein n is 1 to 100, or n is 2 to 80, or n is 3 to 20, or n is 5 to 15.

The one or more ophthalmic device-forming silicone comonomers can include, as a class of representative ophthalmic device-forming silicone comonomers, one or more monomers of Formulas XVI-XX:

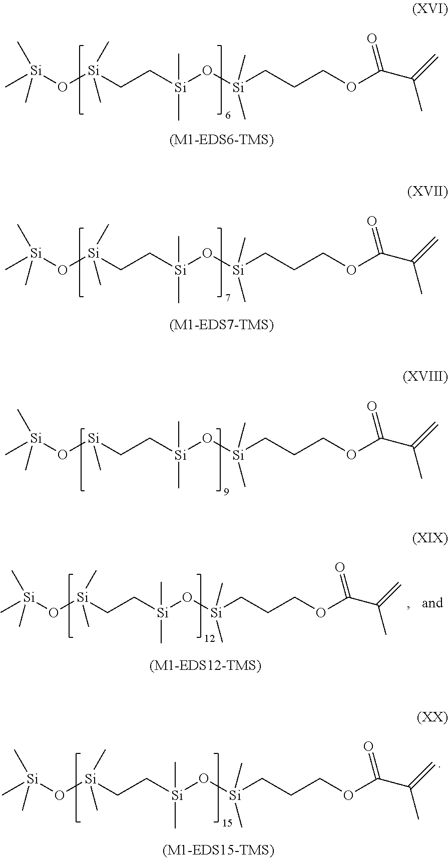

The one or more ophthalmic device-forming silicone comonomers can include, as a class of representative ophthalmic device-forming silicone comonomers, one or more monomers of Formulas XXI-XXIII:

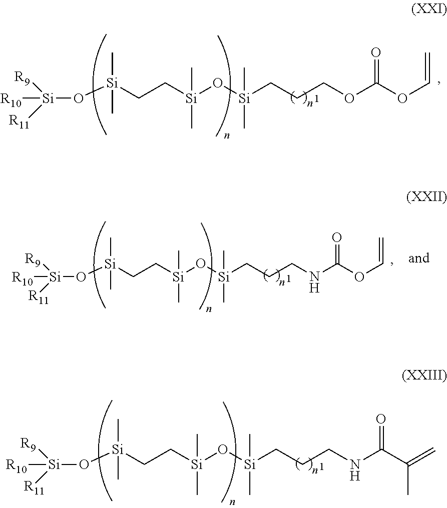

wherein R₉, R₁₀ and R₁₁ are independently hydrogen, an alkyl group, a haloalkyl group or other substituted alkyl groups and n and n¹ are as defined above.

The one or more ophthalmic device-forming silicone comonomers can include, as a class of representative ophthalmic device-forming silicone comonomers, one or more monomers of Formulas XXIV-XXVI:

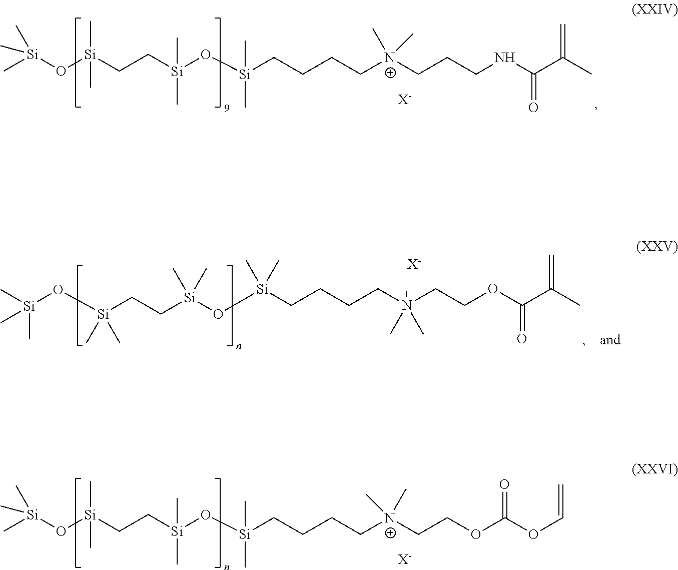

wherein n is as defined above and X⁻ is a counterion to provide an overall neutral charge.

Counterions capable of providing an overall neutral charge are well known to those of ordinary skill in the art and would include, for example, halide ions.

The one or more ophthalmic device-forming silicone comonomers can include, as a class of representative ophthalmic device-forming silicone comonomers, one or more monomers of Formula XXVII:

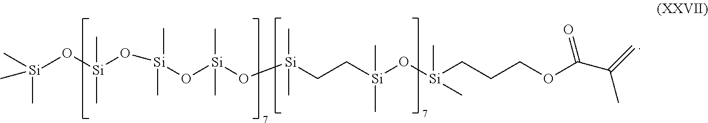

In accordance with one or more additional non-limiting illustrative embodiments, as may be combined with one or more of the preceding paragraphs, the one or more ophthalmic device-forming silicone comonomers can be present in the monomeric mixture in a major amount. In accordance with one or more additional non-limiting illustrative embodiments, as may be combined with one or more of the preceding paragraphs, the one or more ophthalmic device-forming silicone comonomers can be present in the monomeric mixture in an amount greater than about 50 wt. %, based on the total weight of the monomeric mixture. In some embodiments, the one or more ophthalmic device-forming silicone comonomers can be present in the monomeric mixture in an amount greater than about 50 wt. % and up to about 90 wt. %, based on the total weight of the monomeric mixture.

In accordance with one or more additional non-limiting illustrative embodiments, as may be combined with one or more of the preceding paragraphs, the one or more ophthalmic device-forming silicone comonomers can be present in the monomeric mixture in an amount ranging from about 10 wt. % to about 60 wt. %, based on the total weight of the monomeric mixture. In another illustrative embodiment, the one or more ophthalmic device-forming silicone comonomers can be present in the monomeric mixture in an amount ranging from about 15 wt. % to about 50 wt. %, based on the total weight of the monomeric mixture.

The above silicone materials are merely exemplary, and other materials for use as substrates that have been disclosed in various publications and are being continuously developed for use in contact lenses and other silicone hydrogels can also be used. For example, a silicone hydrogel can be formed from at least a cationic monomer such as cationic silicone-containing monomers or cationic fluorinated silicone-containing monomers.

The monomeric mixture further includes one or more crosslinking agents. Suitable crosslinking agents for use herein are known in the art. For example, in non-limiting illustrative embodiments, suitable one or more cross-linking agents include one or more crosslinking agents containing at least two ethylenically unsaturated reactive end groups. In some embodiments, the ethylenically unsaturated reactive end groups are (meth)acrylate-containing reactive end groups. In another embodiment, the ethylenically unsaturated reactive end groups are non-(meth)acrylate reactive end groups. In some embodiments, the ethylenically unsaturated reactive end groups are a combination of one or more (meth)acrylate-containing reactive end groups and one or more non-(meth)acrylate reactive end groups.

In an illustrative embodiment, suitable one or more crosslinking agents containing at least two ethylenically unsaturated reactive end groups include, for example, one or more di-, tri- or tetra(meth)acrylate-containing crosslinking agents. In an illustrative embodiment, useful one or more di-, tri- or tetra(meth)acrylate-containing crosslinking agents include, for example, alkanepolyol di-, tri- or tetra(meth)acrylate-containing crosslinking agents such as, for example, one or more alkylene glycol di(meth)acrylate crosslinking agents, one or more alkylene glycol tri(meth)acrylate crosslinking agents, one or more alkylene glycol tetra(meth)acrylate crosslinking agents, one or more alkanediol di(meth)acrylate crosslinking agents, alkanediol tri(meth)acrylate crosslinking agents, alkanediol tetra(meth)acrylate crosslinking agents, agents, one or more alkanetriol di(meth)acrylate crosslinking agents, alkanetriol tri(meth)acrylate crosslinking agents, alkanetriol tetra(meth)acrylate crosslinking agents, agents, one or more alkanetetraol di(meth)acrylate crosslinking agents, alkanetetraol tri(meth)acrylate crosslinking agents, alkanetetraol tetra(meth)acrylate crosslinking agents and the like and mixtures thereof.

In an illustrative embodiment, one or more alkylene glycol di(meth)acrylate crosslinking agents include tetraethylene glycol dimethacrylate, ethylene glycol di(meth)acrylates having up to about 10 ethylene glycol repeating units, butyleneglycol di(meth)acrylate and the like. In some embodiments, one or more alkanediol di(meth)acrylate crosslinking agents include butanediol di(meth)acrylate crosslinking agents, hexanediol di(meth)acrylate and the like. In some embodiments, one or more alkanetriol tri(meth)acrylate crosslinking agents are trimethylol propane trimethacrylate crosslinking agents. In some embodiments, one or more alkanetetraol tetra(meth)acrylate crosslinking agents are pentaerythritol tetramethacrylate crosslinking agents.

In a non-limiting illustrative embodiment, suitable crosslinking agents include, for example, ethylene glycol diacrylate, diethylene glycol diacrylate, allyl acrylate, 1,3-propanediol diacrylate, 2,3-propanediol diacrylate, 1,6-hexanediol diacrylate, 1,4-butanediol diacrylate, triethylene glycol diacrylate, cyclohexane-1,1-diyldimethanol diacrylate, 1,4-cyclohexanediol diacrylate, 1,3-adamantanediol diacrylate, 1,3-adamantanedimethyl diacrylate, 2,2-diethyl-1,3-propanediol diacrylate, 2,2-diisobutyl-1,3-propanediol diacrylate, 1,3-cyclohexanedimethyl diacrylate, 1,4-cyclohexanedimethyl diacrylate; neopentyl glycol diacrylate, tetraethyleneglycol diacrylate, polyethyleneglycol diacrylate; and their corresponding methacrylates.

In a non-limiting illustrative embodiment, suitable crosslinking agents include, for example, 1,4-butanediol diacrylate, 1,4-butanediol dimethacrylate, ethylene glycol dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, 1,3-propanediol diacrylate, 1,3-propanediol dimethacrylate, 1,6-hexanediol diacrylate, 1,6-hexanediol dimethacrylate, poly(ethylene glycol) diacrylate (Mn=700 Daltons), poly(ethylene glycol) dimethacrylate (Mn=700 Daltons), and poly(ethylene glycol) dimethacrylate (Mn=1000 Daltons).

In some embodiments, the one or more crosslinking agents containing at least two ethylenically unsaturated reactive end groups include at least one allyl-containing reactive end group and at least one (meth)acrylate-containing reactive end group. In an illustrative embodiment, the one or more crosslinking agents can be allyl methacrylate.

In some embodiments, the one or more crosslinking agents are present in the monomeric mixture in an amount of about 0.1 wt. % to about 5.0 wt. %, based on the total weight of the monomeric mixture.

The monomeric mixture can further include one or more functionalized comfort polymers. In non-limiting illustrative embodiments, the one or more functionalized comfort polymers include, for example, a functionalized poloxamer, a functionalized poloxamine and mixtures thereof. A functionalized poloxamer is derived from a poloxamer block copolymer. One specific class of poloxamer block copolymers are those available under the trademark Pluronic (BASF Wyandotte Corp., Wyandotte, Mich.). Poloxamers include Pluronics and reverse Pluronics. Pluronics are a series of ABA block copolymers composed of poly(ethylene oxide)-poly(propylene oxide)-poly(ethylene oxide) blocks as generally represented by the structure:

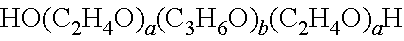

wherein a is independently at least 1 and b is at least 1.

Reverse Pluronics are a series of BAB block copolymers, respectively composed of poly(propylene oxide)-poly(ethylene oxide)-poly(propylene oxide) blocks as generally represented by the structure:

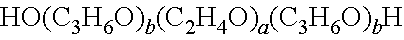

wherein a is at least 1 and b is independently at least 1. The poly(ethylene oxide), PEO, blocks are hydrophilic, whereas the poly(propylene oxide), PPO, blocks are hydrophobic in nature. The poloxamers in each series have varying ratios of PEO and PPO which ultimately determine the hydrophilic-lipophilic balance (HLB) of the material, i.e., the varying HLB values are based upon the varying values of a and b, a representing the number of hydrophilic poly(ethylene oxide) units (PEO) being present in the molecule and b representing the number of hydrophobic poly(propylene oxide) units (PPO) being present in the molecule. In some embodiments, the poloxamer will have an HLB ranging from about 5 to about 24. In another embodiment, the poloxamer will have an HLB ranging from about 1 to about 5.

Poloxamers and reverse poloxamers have terminal hydroxyl groups that can be terminal functionalized to form the functionalized poloxamer. An example of a terminal functionalized poloxamer as discussed herein is poloxamer dimethacrylate (e.g., Pluronic® F127 dimethacrylate) as disclosed in U.S. Patent Application Publication No. 2003/0044468 and U.S. Pat. No. 9,309,357, the contents of which are incorporated by reference herein. Other examples include glycidyl-terminated copolymers of polyethylene glycol and polypropylene glycol as disclosed in U.S. Pat. No. 6,517,933, the contents of which are incorporated by reference herein.

The poloxamer is functionalized to provide the desired reactivity at the end terminal of the molecule. The functionality can be varied and is determined based upon the intended use of the functionalized PEO- and PPO-containing block copolymers. That is, the PEO- and PPO-containing block copolymers are reacted to provide end terminal functionality that is complementary with the intended device forming monomeric mixture. The term block copolymer as used herein shall be understood to mean a poloxamer as having two or more blocks in their polymeric backbone(s). In non-limiting illustrative embodiments, a functionalized poloxamer is a poloxamer di(meth)acrylate, a reverse poloxamer di(meth)acrylate and mixtures thereof.

While the poloxamers and reverse poloxamers are considered to be difunctional molecules (based on the terminal hydroxyl groups), the poloxamines are in a tetrafunctional form, i.e., the molecules are tetrafunctional block copolymers terminating in primary hydroxyl groups and linked by a central diamine. One specific class of poloxamine block copolymers are those available under the trademark Tetronic (BASF). Poloxamines include Tetronic and reverse Tetronics. Poloxamines have the following general structure:

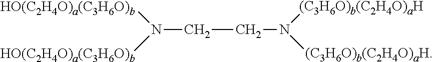

wherein a is independently at least 1 and b is independently at least 1.

The poloxamine can be functionalized to provide the desired reactivity at the end terminal of the molecule. The functionality can be varied and is determined based upon the intended use of the functionalized PEO- and PPO-containing block copolymers. That is, the PEO- and PPO-containing block copolymers are reacted to provide end terminal functionality that is complementary with the intended ophthalmic device forming monomeric mixture. The term block copolymer as used herein shall be understood to mean a poloxamine as having two or more blocks in their polymeric backbone(s).

In some embodiments, the monomeric mixture can include the one or more functionalized comfort polymers in an amount ranging from about 1 wt. % to about 10 wt. %, based on the total weight of the monomeric mixture. In some embodiments, the monomeric mixture can include the one or more functionalized comfort polymers in an amount ranging from about 2 wt. % to about 7 wt. %, based on the total weight of the monomeric mixture.

In non-limiting illustrative embodiments, as may be combined with one or more of the preceding paragraphs, the monomeric mixture can further include a reactive (polymerizable) ultraviolet (UV) light absorber and/or a reactive blue-light absorber. Suitable reactive UV light absorbers can be any known reactive UV absorber. In non-limiting illustrative embodiments, suitable reactive UV light absorbers include, for example, 2-(2′-hydroxy-3′-methallyl-5′-methylphenyl)benzotriazole, commercially available as o-Methallyl Tinuvin P (“oMTP”) from Polysciences, Inc., Warrington, Pa., 3-(2H-benzo[d][1,2,3]triazol-2-yl)-4-hydroxyphenylethyl methacrylate, and 2-(3-(tert-butyl)-4-hydroxy-5-(5-methoxy-2H-benzo[d][1,2,3]triazol-2-yl)phenoxy)ethyl methacrylate.

In one illustrative embodiment, suitable UV light absorbers include, for example, one or more compounds of the following formulae:

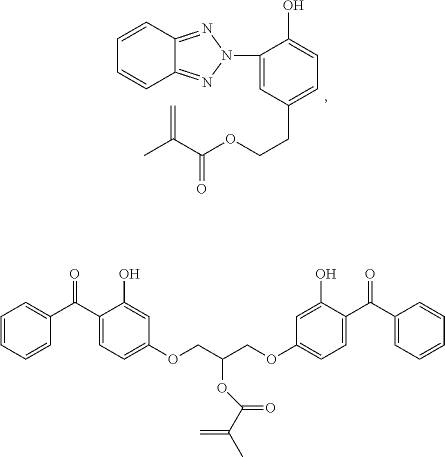 [SMILES: C=C(C)C(=O)OCCc1ccc(O)c(-n2nc3ccccc3n2)c1 ; C=C(C)C(=O)OC(COc1ccc(C(=O)c2ccccc2)c(O)c1)COc1ccc(C(=O)c2ccccc2)c(O)c1]

(2-Propenoic acid, 2-methyl,2-(4-benzoyl-3-hydroxyphenoxy)-1-[(4-benzoyl3-hydroxyphenoxy)methyl ester),

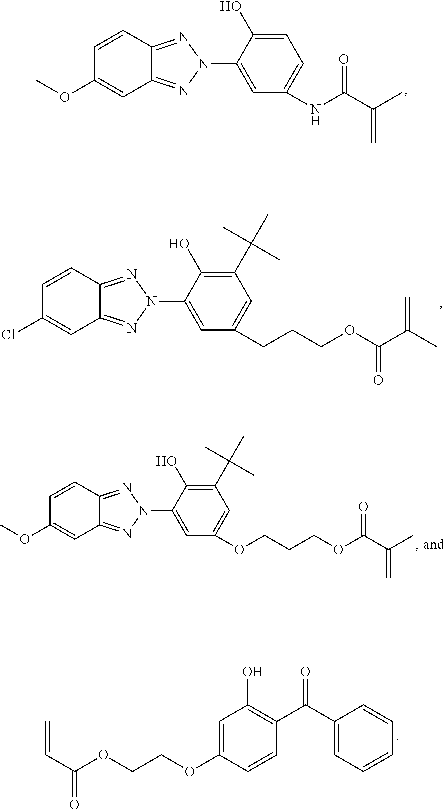

These compounds are merely illustrative and not intended to be limiting. Any known UV blocker or later developed UV blocker are contemplated for use herein.

In illustrative embodiments, the monomeric mixture can include the UV light absorbers in an amount ranging from about 0.1 to about 5 wt. %, based on the total weight of the monomeric mixture. In another illustrative embodiment, the monomeric mixture can include the UV light absorbers in an amount ranging from about 0.1 to about 2 wt. %, based on the total weight of the monomeric mixture.

Many reactive blue-light absorbing compounds are known. Preferred reactive blue-light absorbing compounds are those described in U.S. Pat. Nos. 5,470,932; 8,207,244; and 8,329,775, the contents of which are hereby incorporated by reference. In some embodiments, a blue-light absorbing dye is N-2-[3-(2′-methylphenylazo)-4-hydroxyphenyl]ethyl methacrylamide. In some embodiments, the monomeric mixture can include the blue-light absorbers in an amount ranging from about 0.005 to about 1 wt. %, based on the total weight of the monomeric mixture. In some embodiments, the monomeric mixture can include the blue-light absorbers in an amount ranging from about 0.01 to about 1 wt. %, based on the total weight of the monomeric mixture.

The monomeric mixture may further contain, as necessary and within limits not to impair the purpose and effect of the illustrative embodiments, various additives such as an antioxidant, a coloring agent, a lubricant, an internal wetting agent, a toughening agent and the like and other constituents as are well known in the art.

The ophthalmic devices disclosed herein can be a high-water content silicone ophthalmic device such as silicone hydrogel having an equilibrium water content of at least about 35 wt. %. In another illustrative embodiment, the high-water content silicone ophthalmic device disclosed herein can have an equilibrium water content of at least about 50 wt. %. In another illustrative embodiment, the high-water content silicone ophthalmic device disclosed herein can have an equilibrium water content of at least about 60 wt. %. In another illustrative embodiment, the high-water content silicone ophthalmic device disclosed herein can have an equilibrium water content of at least about 70 wt. %. In another illustrative embodiment, the ophthalmic devices disclosed herein can be a high-water content silicone ophthalmic device having an equilibrium water content of from about 35 wt. % to about 80 wt. %.

The ophthalmic devices of the illustrative embodiments, e.g., contact lenses or intraocular lenses, can be prepared by polymerizing the foregoing monomeric mixtures to form a product that can be subsequently formed into the appropriate shape by, for example, lathing, injection molding, compression molding, cutting and the like. For example, in producing contact lenses, the initial mixture may be polymerized in tubes to provide rod-shaped articles, which are then cut into buttons. The buttons may then be lathed into contact lenses.

Alternately, the ophthalmic devices such as contact lenses may be cast directly in molds, e.g., polypropylene molds, from the mixtures, e.g., by spincasting and static casting methods. Spincasting methods are disclosed in U.S. Pat. Nos. 3,408,429 and 3,660,545, and static casting methods are disclosed in U.S. Pat. Nos. 4,113,224, 4,197,266, and 5,271,875. Spincasting methods involve charging the mixtures to be polymerized to a mold, and spinning the mold in a controlled manner while exposing the mixture to a radiation source such as UV light. Static casting methods involve charging the monomeric mixture between two mold sections, one mold section shaped to form the anterior lens surface and the other mold section shaped to form the posterior lens surface, and curing the mixture while retained in the mold assembly to form a lens, for example, by free radical polymerization of the mixture. Examples of free radical reaction techniques to cure the lens material include thermal radiation, infrared radiation, electron beam radiation, gamma radiation, ultraviolet (UV) radiation, and the like; or combinations of such techniques may be used. U.S. Pat. No. 5,271,875 describes a static cast molding method that permits molding of a finished lens in a mold cavity defined by a posterior mold and an anterior mold. As an additional method, U.S. Pat. No. 4,555,732 discloses a process where an excess of a monomeric mixture is cured by spincasting in a mold to form a shaped article having an anterior lens surface and a relatively large thickness, and the posterior surface of the cured spincast article is subsequently lathed to provide a contact lens having the desired thickness and posterior lens surface.

Polymerization may be facilitated by exposing the mixture to heat (thermal cure) and/or radiation, such as ultraviolet light, visible light, or high energy radiation. A polymerization initiator may be included in the mixture to facilitate the polymerization step. Representative examples of free radical thermal polymerization initiators include organic peroxides such as acetyl peroxide, lauroyl peroxide, decanoyl peroxide, stearoyl peroxide, benzoyl peroxide, tertiarylbutyl peroxypivalate, peroxydicarbonate, and the like. Representative examples of diazo initiators include VAZO 64, and VAZO 67. Representative UV initiators are those known in the art and include benzoin methyl ether, benzoin ethyl ether, Darocur® 1173, 1164, 2273, 1116, 2959, 3331 (EM Industries) and Irgacure® 651 and 184 (Ciba-Geigy). Representative visible light initiators include IRGACURE 819 and other phosphine oxide-type initiators, and the like. Generally, the initiator will be employed in the monomeric mixture at a concentration of about 0.01 wt. % to about 5 wt. % of the total mixture.

Polymerization is generally performed in a reaction medium, such as, for example, a solution or dispersion using a diluent or solvent, e.g., water, methoxypropyl acetate or an alkanol containing from 1 to 4 carbon atoms such as methanol, ethanol or propan-2-ol. Alternatively, a mixture of any of the above solvents may be used.

Generally, polymerization can be carried out from anywhere from about 15 seconds to about 72 hours. The polymerization can be carried out under an inert atmosphere of, for example, nitrogen or argon. If desired, the resulting polymerization product can be dried under vacuum, e.g., for about 5 to about 72 hours, or left in an aqueous solution prior to use.

Polymerization of the mixtures will yield a polymer, that when hydrated, preferably forms a hydrogel. When producing a hydrogel lens, the mixture may further include at least a diluent as discussed above that is ultimately replaced with water when the polymerization product is hydrated to form a hydrogel. Generally, the water content of the hydrogel is as described hereinabove. The amount of diluent used should be less than about 50 wt. % and in most cases, the diluent content will be less than about 30 wt. %. However, in a particular polymer system, the actual limit will be dictated by the solubility of the various monomers in the diluent. In order to produce an optically clear copolymer, it is important that a phase separation leading to visual opacity does not occur between the comonomers and the diluent, or the diluent and the final copolymer.

Furthermore, the maximum amount of diluent which may be used will depend on the amount of swelling the diluent causes the final polymers. Excessive swelling will or may cause the copolymer to collapse when the diluent is replaced with water upon hydration. Suitable diluents include, but are not limited to, ethylene glycol; glycerine; liquid poly(ethylene glycol); alcohols; alcohol/water mixtures; ethylene oxide/propylene oxide block copolymers; low molecular weight linear poly(2-hydroxyethyl methacrylate); glycol esters of lactic acid; formamides; ketones; dialkylsulfoxides; butyl carbitol; borates as discussed herein and the like and mixtures thereof.

If necessary, it may be desirable to remove residual diluent from the lens before edge-finishing operations which can be accomplished by evaporation at or near ambient pressure or under vacuum. An elevated temperature can be employed to shorten the time necessary to evaporate the diluent. The time, temperature and pressure conditions for the solvent removal step will vary depending on such factors as the volatility of the diluent and the specific monomeric components, as can be readily determined by one skilled in the art. If desired, the mixture used to produce the hydrogel lens may further include wetting agents known in the prior art for making hydrogel materials.

The ophthalmic devices such as contact lenses obtained herein may be subjected to optional machining operations. For example, the optional machining steps may include buffing or polishing a lens edge and/or surface. Generally, such machining processes may be performed before or after the product is released from a mold part, e.g., the lens is dry released from the mold by employing vacuum tweezers to lift the lens from the mold, after which the lens is transferred by means of mechanical tweezers to a second set of vacuum tweezers and placed against a rotating surface to smooth the surface or edges. The lens may then be turned over in order to machine the other side of the lens.

The lens may then be transferred to individual lens packages containing a buffered saline solution. The saline solution may be added to the package either before or after transfer of the lens. Appropriate packaging designs and materials are known in the art. A plastic package is releasably sealed with a film. Suitable sealing films are known in the art and include foils, polymer films and mixtures thereof. The sealed packages containing the lenses are then sterilized to ensure a sterile product. Suitable sterilization means and conditions are known in the art and include, for example, autoclaving.

As one skilled in the art will readily appreciate other steps may be included in the molding and packaging process described above. Such other steps can include, for example, coating the formed lens, surface treating the lens during formation (e.g., via mold transfer), inspecting the lens, discarding defective lenses, cleaning the mold halves, reusing the mold halves, and the like and combinations thereof.

The following examples are provided to enable one skilled in the art to practice the invention and are merely illustrative. The examples should not be read as limiting the scope of the invention as defined in the claims.

In the examples, the following abbreviations are used.

IEM: 2-isocyanatoethyl methacrylate.

IEEM: 2-(2-Isocyanatoethoxy)ethyl methacrylate.

Tris-NH₂: 3-Aminopropyl-tris(trimethylsiloxy)silane.

Bis-NH₂: 3-Aminopropylmethyl-bis(trimethylsiloxy)silane.

MPA: Methoxypropyl acetate.

MCR-A11: Mono-aminopropyl terminated polydimethylsiloxane.

HEA: 2-hydroxyethyl acrylate.

HEMA: 2-hydroxyethyl methacrylate.

TRIS MA: Tris (trimethoxysilylpropyl)methacrylate.

NVP: N-vinyl-2-pyrrolidone.

DMA: N,N-dimethylacrylamide.

EGDMA: Ethylene glycol dimethacrylate.

HR6100 (Miwon Energy Curing Products) is a compound represented by the following structure:

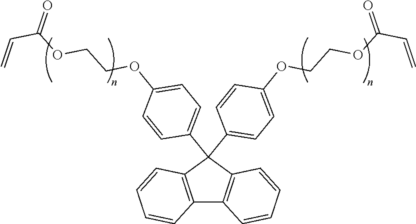

MPC: Methacryloyl phosphorylcholine.

Irg819: Irgacure 819 photoinitiator.

MCR-M11: A compound represented by the structure:

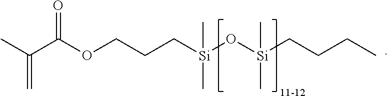

X-22-1666C: A compound available from ShinEtsu and represented by the following structure:

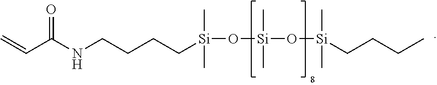

Tris-IEM: A compound represented by the following structure:

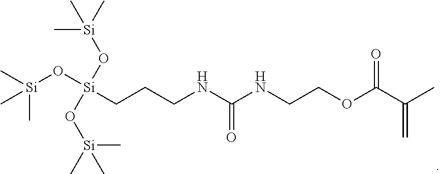 [SMILES: C=C(C)C(=O)OCCNC(=O)NCCC[Si](O[Si](C)(C)C)(O[Si](C)(C)C)O[Si](C)(C)C]

### Example 1

Preparation of a monofunctional urea-based organosilicon monomer (MCR-A11-IEM) having the following structure:

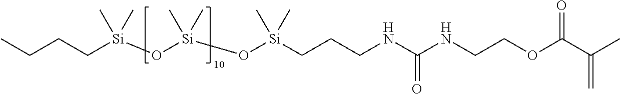

by the general reaction scheme.

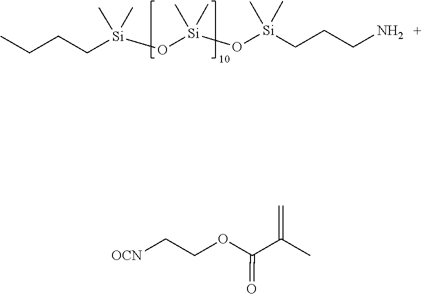

A glass jar was fitted with a magnetic stir bar and a thermocouple and clamped onto a magnetic stirring plate. The glass jar was charged with 1.360 g (8.77 mmol) IEM, and 10.01 g (8.81 mmol) MCR-A11 was added in one portion. The reaction mixture exothermed to roughly 40° C. within a few minutes of amine addition and was allowed to gradually return to room temperature yielding a viscous but pourable clear, faintly yellowish liquid in quantitative yield. H-NMR in CDCl₃ confirmed the compound in high purity.

### Example 2

Preparation of a monofunctional urea-based organosilicon monomer (MCR-A11-IEM) having the following structure:

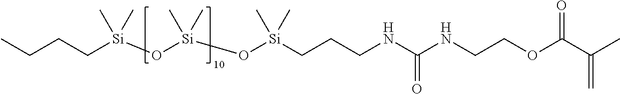

by the general reaction scheme.

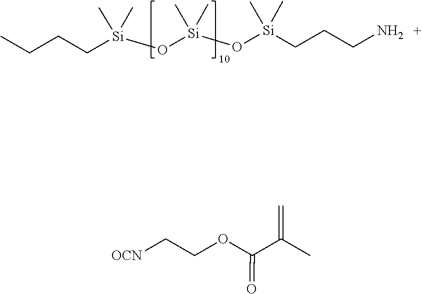

A glass jar was fitted with a magnetic stir bar and a thermocouple and clamped onto a magnetic stirring plate. The glass jar was charged with 4.513 g (29.09 mmol, 1.1 eq) IEM, and 30.009 g (26.42 mmol) MCR-A11 was added in one portion. The reaction mixture exothermed to roughly 50° C. within a few minutes of amine addition and was allowed to gradually return to room temperature yielding a viscous but pourable clear, faintly yellowish liquid in quantitative yield. H-NMR in CDCl₃ confirmed the compound in high purity.

### Examples 3-8 and Comparative Examples A-F

In 12 separate vials at room temperature were weighed 0.5 g silicone, followed by weighing 0.5 g hydrophilic monomer. The vials were stirred at room temperature and miscibility behavior recorded. The vials were individually warmed gradually to 35° C. with stirring, and miscibility behavior recorded. The vials were then individually warmed gradually to 60° C. with stirring, and miscibility behavior recorded. Miscibility was determined by presence or absence of cloudiness (immiscibility or miscibility, respectively). The components and miscibility results for each silicone/hydrophilic monomer mixture are set forth below in Table 1.

TABLE 1

| | | | Hydro- | | | |
|---|---|---|---|---|---|---|
| Comp. | | Link- | philic | RT | 35° C. | 60° C. |
| Ex./ | | ing | Mono- | Misci- | Misci- | Misci- |
| Ex. | Silicone | Group | mer | bility | bility | bility |
| A | MCR-M11 | Ester | HEA | No | No | No |
| B | MCR-M11 | Ester | HEMA | No | No | No |
| C | MCR-M11 | Ester | DMA | No | No | Yes |
| D | X-22-1666C | Amide | HEA | No | No | No |
| E | X-22-1666C | Amide | HEMA | No | No | Yes |
| F | X-22-1666C | Amide | DMA | No | Yes | Yes |
| 3 | MCR-A11-IEM | Urea | HEA | No | No | Yes |
| | of Ex. 1 | | | | | |
| 4 | MCR-A11-IEM | Urea | HEMA | Yes | Yes | Yes |
| | of Ex. 1 | | | | | |
| 5 | MCR-A11-IEM | Urea | DMA | Yes | Yes | Yes |
| | of Ex. 1 | | | | | |
| 6 | 1:1 Tris- | Urea | HEA | No | Yes | Yes |
| | IEM:MCR-A11- | | | | | |
| | IEM of Ex. 1 | | | | | |
| 7 | 1:1 Tris- | Urea | HEMA | Yes | Yes | Yes |
| | IEM:MCR-A11- | | | | | |
| | IEM of Ex. 1 | | | | | |
| 8 | 1:1 Tris- | Urea | DMA | Yes | Yes | Yes |
| | IEM:MCR-A11- | | | | | |
| | IEM of Ex. 1 | | | | | |

Immiscible combinations denoted “No” for miscibility, and miscible combinations denoted “Yes” for miscibility. While not wishing to be bound by theory, the miscibility data shows a trend of increasing miscibility from ester to amide to urea linkage.

### Example 9

A monomeric mix was made by mixing the following components, listed in Table 2 at amounts per weight.

TABLE 2

| Formulation | Wt. % |
|---|---|
| Tris-IEM | 19.3 |
| 11.19% MPC:DMA:HEA | 46.4 |
| MCR-A11-IEM of Ex. 1 | 19.6 |
| IRG819 | 1.0 |
| EGDMA | 4.6 |
| MPA diluent | 9.1 |

The 11.19% MPC:DMA:HEA mixture was made by mixing MPC, DMA and HEA, listed in Table 3 at amounts per weight.

TABLE 3

| Formulation | Wt. % |
|---|---|
| MPC | 11.19 |
| DMA | 58.02 |
| HEA | 30.79 |

The resultant monomeric mixture was cast into contact lenses as follows. Irg819 was dissolved in 11% MPC:DMA:HEA. EGDMA and MPA were added and stirred to dissolve, followed by adding Tris-IEM. The mixture was stirred at room temperature. Next, MCR-A11-IEM was added, and the mixture was stirred to combine the components. Contact lenses were formed by aliquoting 3 drops of the monomeric mixture into −3.00 Ultra molds and cured for 20 seconds each with an LED curing light centered at 450 nm (blue light, ˜3 W/cm²). The contact lenses were dry released, submerged in BBS, sealed in glass vials, and autoclaved. The dry released contact lenses were clear and colorless, and the autoclaved lenses were clear and colorless.

### Example 10

A monomeric mix was made by mixing the following components, listed in Table 4 at amounts per weight.

TABLE 4

| Formulation | Wt. % |
|---|---|
| Tris-IEM | 18.5 |
| 16.37% MPC:HEA | 35.3 |
| MCR-A11-IEM of Ex. 1 | 18.9 |
| DMA | 17.8 |
| IRG819 | 0.9 |
| HR6100 | 1.4 |
| MPA diluent | 7.2 |

The 16.37% MPC:HEA mixture was made by mixing MPC and HEA, listed in Table 5 at amounts per weight.

TABLE 5

| Formulation | Wt. % |
|---|---|
| MPC | 16.37 |
| HEA | 83.63 |

The resultant monomeric mixture was cast into contact lenses as follows. Irg819 was dissolved in 16.37 MPC:HEA. HR6100 and MPA were added and stirred to dissolve, followed by the addition of Tris-IEM. The mixture was stirred at room temperature. Next, MCR-A11-IEM was added, and the mixture was stirred to combine the components. Contact lenses were formed by aliquoting 3 drops of the monomeric mixture into −3.00 Ultra molds and cured for 20 seconds each with an LED curing light centered at 450 nm (blue light, ˜3 W/cm²). The contact lenses were dry released, submerged in BBS, sealed in glass vials, and autoclaved. The dry released contact lenses were clear and colorless, and the autoclaved lenses were clear and colorless.

### Example 11

A monomeric mix was made by mixing the following components, listed in Table 6 at amounts per weight.

TABLE 6

| Formulation | Wt. % |
|---|---|
| Tris-IEM | 18.9 |
| 16.37% MPC:HEA | 36.7 |
| MCR-A11-IEM of Ex. 1 | 19.3 |
| DMA | 19.1 |
| IRG819 | 0.8 |
| HR6100 | 1.5 |
| MPA diluent | 7.9 |

The 16.37% MPC:HEA mixture was made by mixing MPC and HEA, listed in Table 7 at amounts per weight.

TABLE 7

| Formulation | Wt. % |
|---|---|
| MPC | 16.37 |
| HEA | 83.63 |

The resultant monomeric mixture was cast into contact lenses as follows. Irg819 was dissolved in 16.37 MPC:HEA. HR6100 and MPA were added and stirred to dissolve, followed by the addition of Tris-IEM. The mixture was stirred at room temperature. Next, MCR-A11-IEM was added, and the mixture was stirred to combine the components. Contact lenses were formed by aliquoting 3 drops of the monomeric mixture into −3.00 Ultra molds and cured for 20 seconds each with an LED curing light centered at 450 nm (blue light, ˜3 W/cm²). The contact lenses were dry released, submerged in BBS, sealed in glass vials, and autoclaved. The dry released contact lenses were clear and colorless, and the autoclaved lenses were clear and colorless.

### Example 12

A monomeric mix was made by mixing the following components, listed in Table 8 at amounts per weight.

TABLE 8

| Formulation | Wt. % |
|---|---|
| Tris-IEM | 20.4 |
| 16.37% MPC:HEA | 32.2 |
| MCR-A11-IEM of Ex. 1 | 20.6 |
| DMA | 16.8 |
| IRG819 | 0.9 |
| HR6100 | 1.4 |
| MPA diluent | 7.7 |

The 16.37% MPC:HEA mixture was made by mixing MPC and HEA, listed in Table 9 at amounts per weight.

TABLE 9

| Formulation | Wt. % |
|---|---|
| MPC | 16.37 |
| HEA | 83.63 |

The resultant monomeric mixture was cast into contact lenses as follows. IHR6100 and Irg819 were added to a tared vial, followed by 16.37 MPC:HEA and MPA. The mixture was stirred at room temperature. The solids were heated gently to about 35° C. to dissolve the solids. Tris-IEM was added and mixed, followed by MCR-A11-IEM and additional mixing to combine the components. Contact lenses were formed by aliquoting 3 drops of the monomeric mixture into −3.00 Ultra molds and cured for 20 seconds each with an LED curing light centered at 450 nm (blue light, ˜3 W/cm²). The contact lenses were dry released, submerged in BBS, sealed in glass vials, and autoclaved. The dry released contact lenses were clear and colorless, and the autoclaved lenses were clear and colorless.

### Example 13

A monomeric mix was made by mixing the following components, listed in Table 10 at amounts per weight.

TABLE 10

| Formulation | Wt. % |
|---|---|
| Tris-IEM | 20.5 |
| 11.19% MPC:DMA:HEA | 49.2 |
| MCR-A11-IEM of Ex. 1 | 20.3 |
| IRG819 | 1.0 |
| HR6100 | 1.3 |
| MPA diluent | 7.8 |

The 11.19% MPC:DMA:HEA mixture was made by mixing MPC, DMA and HEA, listed in Table 11 at amounts per weight.

TABLE 11

| Formulation | Wt. % |
|---|---|
| MPC | 11.19 |
| DMA | 58.02 |
| HEA | 30.79 |

The resultant monomeric mixture was cast into contact lenses as follows. IHR6100 and Irg819 were added to a tared vial, followed by 11.19 MPC:DMA:HEA and MPA. The mixture was stirred at room temperature. The solids were heated gently to about 35° C. to dissolve the solids. Tris-IEM was added and mixed, followed by MCR-A11-IEM and additional mixing to combine the components. Contact lenses were formed by aliquoting 3 drops of the monomeric mixture into −3.00 Ultra molds and cured for 20 seconds each with an LED curing light centered at 450 nm (blue light, ˜3 W/cm²). The contact lenses were dry released, submerged in BBS, sealed in glass vials, and autoclaved. The dry released contact lenses were clear and colorless, and the autoclaved lenses were clear and colorless.

According to an aspect of the present disclosure, a monofunctional urea-based organosilicon monomer is represented by a structure of Formula I:

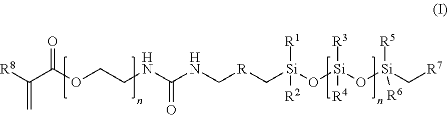

wherein R is an alkylene group; R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; R⁸ is hydrogen or methyl; m is at least 1; and n is at least 1.

In non-limiting illustrative embodiments, as may be combined with one or more of the preceding paragraphs, R is a C₁ to C₆ alkylene group, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group, R⁸ is hydrogen or methyl, m is 1 to 20 and n is from 1 to 12.

In non-limiting illustrative embodiments, as may be combined with one or more of the preceding paragraphs, R is a C₁ to C₆ alkylene group, R¹, R², R³ and R⁴ are independently hydrogen, or a C₁ to C₆ alkyl group; R⁵, R⁶ and R⁷ are independently a straight or branched C₁ to C₆ alkyl group, R⁸ is hydrogen or methyl, m is from 5 to 15, and n is from 1 to 3.

In non-limiting illustrative embodiments, as may be combined with one or more of the preceding paragraphs, R is a C₁ to C₆ alkylene group, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group, R⁸ is hydrogen or methyl, m is from 5 to 15; and n is from 1 to 3.

According to another aspect of the present disclosure, an ophthalmic device comprises a polymerization product of a monomeric mixture comprising:
(a) one or more monofunctional urea-based organosilicon monomers represented by a structure of Formula I:

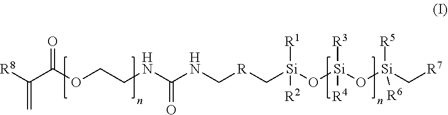

wherein R is an alkylene group; R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; R⁸ is hydrogen or methyl; m is at least 1; and n is at least 1; and
(b) one or more ophthalmic device-forming hydrophilic comonomers or polymers.

In non-limiting illustrative embodiments, as may be combined with one or more of the preceding paragraphs, wherein in the one or more monofunctional urea-based organosilicon monomers, R is a C₁ to C₆ alkylene group, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group, R⁸ is hydrogen or methyl, m is 1 to 20 and n is from 1 to 12.

In non-limiting illustrative embodiments, as may be combined with one or more of the preceding paragraphs, wherein in the one or more monofunctional urea-based organosilicon monomers, R is a C₁ to C₆ alkylene group, R¹, R², R³ and R⁴ are independently hydrogen, or a C₁ to C₆ alkyl group; R⁵, R⁶ and R⁷ are independently a straight or branched C₁ to C₆ alkyl group, R⁸ is hydrogen or methyl, m is from 5 to 15, and n is from 1 to 3.

In non-limiting illustrative embodiments, as may be combined with one or more of the preceding paragraphs, wherein in the one or more monofunctional urea-based organosilicon monomers, R is a C₁ to C₆ alkylene group, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group, R⁸ is hydrogen or methyl, m is from 5 to 15; and n is from 1 to 3.

In non-limiting illustrative embodiments, as may be combined with one or more of the preceding paragraphs, wherein the one or more ophthalmic device-forming hydrophilic comonomers or polymers are selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups.

In non-limiting illustrative embodiments, as may be combined with one or more of the preceding paragraphs, the one or more ophthalmic device-forming hydrophilic comonomers or polymers are one or more hydrophilic acrylate or acrylamide comonomers.

In non-limiting illustrative embodiments, as may be combined with one or more of the preceding paragraphs, the one or more hydrophilic acrylate or acrylamide comonomers comprise 2-hydroxyethyl acrylate and dimethylacrylamide.

In non-limiting illustrative embodiments, as may be combined with one or more of the preceding paragraphs, the monomeric mixture comprises:
about 1 wt. % to about 50 wt. %, based on the total weight of the monomeric mixture, of the one or more monofunctional urea-based organosilicon monomers; and
about 50 wt. % to about 90 wt. %, based on the total weight of the monomeric mixture, of the one or more ophthalmic device-forming hydrophilic comonomers or polymers.

In non-limiting illustrative embodiments, as may be combined with one or more of the preceding paragraphs, the monomeric mixture further comprises one or more monofunctional urea-based silicone monomers represented by a structure of Formula II:

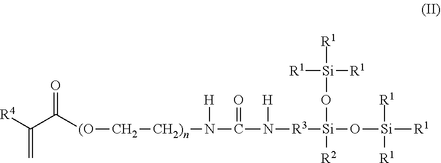

wherein each R¹ is independently an alkyl group; R² is an alkyl group or a trialkyl siloxy group, R³ is an alkylene group, R⁴ is hydrogen or methyl and n is an integer from 1 to 12.

In non-limiting illustrative embodiments, as may be combined with one or more of the preceding paragraphs, R¹ and R² are independently a C₁ to C₆ alkyl group; R³ is a C₁ to C₆ alkylene group; and n is from 1 to 3.

In non-limiting illustrative embodiments, as may be combined with one or more of the preceding paragraphs, R¹ and R² are independently a C₁ to C₃ alkyl group; R³ is a C₁ to C₃ alkylene group; and n is from 1 to 3.

In non-limiting illustrative embodiments, as may be combined with one or more of the preceding paragraphs, R¹ and R² are independently a C₁ to C₃ alkyl group; R³ is a C₁ to C₃ alkylene group; and n is from 3 to 5.

In non-limiting illustrative embodiments, as may be combined with one or more of the preceding paragraphs, R¹ is a C₁ to C₆ alkyl group; R² is a tri C₁ to C₆ alkyl siloxy group, R³ is a C₁ to C₆ alkylene group; and n is from 1 to 3.

In non-limiting illustrative embodiments, as may be combined with one or more of the preceding paragraphs, R¹ is a C₁ to C₃ alkyl group; R² is a tri C₁ to C₃ alkyl siloxy group, R³ is a C₁ to C₃ alkylene group; and n is from 1 to 3.

In non-limiting illustrative embodiments, as may be combined with one or more of the preceding paragraphs, R¹ is a C₁ to C₃ alkyl group; R² is a tri C₁ to C₃ alkyl siloxy group, R³ is a C₁ to C₃ alkylene group; and n is from 3 to 5.

In non-limiting illustrative embodiments, as may be combined with one or more of the preceding paragraphs, the monomeric mixture comprises from about 1 wt. % to about 50 wt. %, based on the total weight of the monomeric mixture, of the one or more monofunctional urea-based silicone monomers represented by the structure of Formula II.

In non-limiting illustrative embodiments, as may be combined with one or more of the preceding paragraphs, the monomeric mixture further comprises one or more non-functionalized comfort polymers.

In non-limiting illustrative embodiments, as may be combined with one or more of the preceding paragraphs, the one or more non-functionalized comfort polymers comprise a polyvinylpyrrolidone polymer having a weight average molecular weight of at least about 10,000 Daltons.

In non-limiting illustrative embodiments, as may be combined with one or more of the preceding paragraphs, the monomeric mixture further comprises one or more of one or more functionalized comfort polymers, one or more crosslinking agents, one or more reactive ultraviolet light absorbers and one or more reactive blue-light absorbers.

In non-limiting illustrative embodiments, as may be combined with one or more of the preceding paragraphs, the ophthalmic device has an equilibrium water content of from about 35 wt. % to about 80 wt. %.

In non-limiting illustrative embodiments, as may be combined with one or more of the preceding paragraphs, the ophthalmic device is a silicon hydrogel which is optically clear.

According to yet another aspect of the present disclosure, a method for making an ophthalmic device, comprises:
(a) curing a monomeric mixture in a mold, the monomeric mixture comprising:
(i) one or more monofunctional urea-based organosilicon monomers represented by a structure of Formula I:

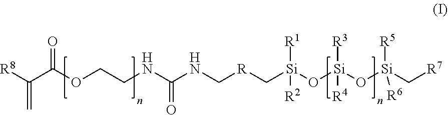

wherein R is an alkylene group; R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; R⁸ is hydrogen or methyl; m is at least 1; and n is at least 1, and
(ii) one or more ophthalmic device-forming hydrophilic comonomers or polymers, and
(b) dry releasing the ophthalmic device from the mold.

In non-limiting illustrative embodiments, as may be combined with one or more of the preceding paragraphs, wherein in the one or more monofunctional urea-based organosilicon monomers, R is a C₁ to C₆ alkylene group, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group, R⁸ is hydrogen or methyl, m is 1 to 20 and n is from 1 to 12.

In non-limiting illustrative embodiments, as may be combined with one or more of the preceding paragraphs, wherein in the one or more monofunctional urea-based organosilicon monomers, R is a C₁ to C₆ alkylene group, R¹, R², R³ and R⁴ are independently hydrogen, or a C₁ to C₆ alkyl group; R⁵, R⁶ and R⁷ are independently a straight or branched C₁ to C₆ alkyl group, R⁸ is hydrogen or methyl, m is from 5 to 15, and n is from 1 to 3.

In non-limiting illustrative embodiments, as may be combined with one or more of the preceding paragraphs, wherein in the one or more monofunctional urea-based organosilicon monomers, R is a C₁ to C₆ alkylene group, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group, R⁸ is hydrogen or methyl, m is from 5 to 15; and n is from 1 to 3.

In non-limiting illustrative embodiments, as may be combined with one or more of the preceding paragraphs, wherein the one or more ophthalmic device-forming hydrophilic comonomers or polymers are selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups.

In non-limiting illustrative embodiments, as may be combined with one or more of the preceding paragraphs, the one or more ophthalmic device-forming hydrophilic comonomers or polymers are one or more hydrophilic acrylate or acrylamide comonomers.

In non-limiting illustrative embodiments, as may be combined with one or more of the preceding paragraphs, the one or more hydrophilic acrylate or acrylamide comonomers comprise 2-hydroxyethyl acrylate and dimethylacrylamide.

In non-limiting illustrative embodiments, as may be combined with one or more of the preceding paragraphs, the monomeric mixture comprises:
about 1 wt. % to about 50 wt. %, based on the total weight of the monomeric mixture, of the one or more monofunctional urea-based organosilicon monomers, and
about 50 wt. % to about 90 wt. %, based on the total weight of the monomeric mixture, of the one or more ophthalmic device-forming hydrophilic comonomers or polymers.

In non-limiting illustrative embodiments, as may be combined with one or more of the preceding paragraphs, the monomeric mixture further comprises one or more monofunctional urea-based silicone monomers represented by a structure of Formula II:

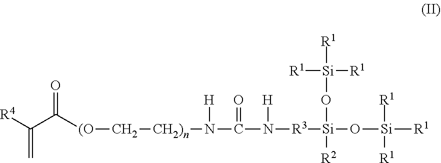

wherein each R¹ is independently an alkyl group; R² is an alkyl group or a trialkyl siloxy group, R³ is an alkylene group, R⁴ is hydrogen or methyl and n is an integer from 1 to 12.

In non-limiting illustrative embodiments, as may be combined with one or more of the preceding paragraphs, R¹ and R² are independently a C₁ to C₆ alkyl group; R³ is a C₁ to C₆ alkylene group; and n is from 1 to 3.

In non-limiting illustrative embodiments, as may be combined with one or more of the preceding paragraphs, R¹ and R² are independently a C₁ to C₃ alkyl group; R³ is a C₁ to C₃ alkylene group; and n is from 1 to 3.

In non-limiting illustrative embodiments, as may be combined with one or more of the preceding paragraphs, R¹ and R² are independently a C₁ to C₃ alkyl group; R³ is a C₁ to C₃ alkylene group; and n is from 3 to 5.

In non-limiting illustrative embodiments, as may be combined with one or more of the preceding paragraphs, R¹ is a C₁ to C₆ alkyl group; R² is a tri C₁ to C₆ alkyl siloxy group, R³ is a C₁ to C₆ alkylene group; and n is from 1 to 3.

In non-limiting illustrative embodiments, as may be combined with one or more of the preceding paragraphs, R¹ is a C₁ to C₃ alkyl group; R² is a tri C₁ to C₃ alkyl siloxy group, R³ is a C₁ to C₃ alkylene group; and n is from 1 to 3.

In non-limiting illustrative embodiments, as may be combined with one or more of the preceding paragraphs, R¹ is a C₁ to C₃ alkyl group; R² is a tri C₁ to C₃ alkyl siloxy group, R³ is a C₁ to C₃ alkylene group; and n is from 3 to 5.

In non-limiting illustrative embodiments, as may be combined with one or more of the preceding paragraphs, the monomeric mixture comprises from about 1 wt. % to about 50 wt. %, based on the total weight of the monomeric mixture, of the one or more monofunctional urea-based silicone monomers represented by the structure of Formula II.

In non-limiting illustrative embodiments, as may be combined with one or more of the preceding paragraphs, the monomeric mixture further comprises one or more non-functionalized comfort polymers.

In non-limiting illustrative embodiments, as may be combined with one or more of the preceding paragraphs, the one or more non-functionalized comfort polymers comprise a polyvinylpyrrolidone polymer having a weight average molecular weight of at least about 10,000 Daltons.

In non-limiting illustrative embodiments, as may be combined with one or more of the preceding paragraphs, the monomeric mixture further comprises one or more of one or more functionalized comfort polymers, one or more crosslinking agents, one or more reactive ultraviolet light absorbers and one or more reactive blue-light absorbers.

In non-limiting illustrative embodiments, as may be combined with one or more of the preceding paragraphs, the ophthalmic device has an equilibrium water content of from about 35 wt. % to about 80 wt. %.

In non-limiting illustrative embodiments, as may be combined with one or more of the preceding paragraphs, the ophthalmic device is a silicon hydrogel which is optically clear.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

It will be understood that various modifications may be made to the embodiments disclosed herein. Therefore, the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A monofunctional urea-based organosilicon monomer represented by a structure of Formula I: 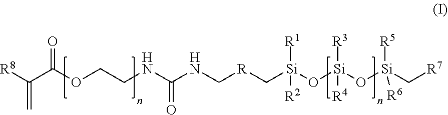
wherein R is an alkylene group; R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; R⁸ is hydrogen or methyl; m is at least 1; and n is at least 1.

2. The monofunctional urea-based organosilicon monomer according to claim 1, wherein R is a C₁ to C₆ alkylene group, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group, R⁸ is hydrogen or methyl, m is 1 to 20 and n is from 1 to 12.

3. The monofunctional urea-based organosilicon monomer according to claim 1, wherein R is a C₁ to C₆ alkylene group, R¹, R², R³ and R⁴ are independently hydrogen, or a C₁ to C₆ alkyl group; R⁵, R⁶ and R⁷ are independently a straight or branched C₁ to C₆ alkyl group, R⁸ is hydrogen or methyl, m is from 5 to 15, and n is from 1 to 3.

4. The monofunctional urea-based organosilicon monomer according to claim 1, wherein R is a C₁ to C₆ alkylene group, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group, R⁸ is hydrogen or methyl, m is from 5 to 15; and n is from 1 to 3.

5. An ophthalmic device comprising a polymerization product of a monomeric mixture comprising:
(a) one or more monofunctional urea-based organosilicon monomers represented by a structure of Formula I: 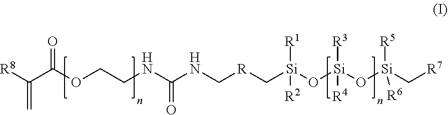
wherein R is an alkylene group; R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; R⁸ is hydrogen or methyl; m is at least 1; and n is at least 1; and
(b) one or more ophthalmic device-forming hydrophilic comonomers or polymers or polymers.

6. The ophthalmic device according to claim 5, wherein in the one or more monofunctional urea-based organosilicon monomers, R is a C₁ to C₆ alkylene group, R¹, R², R³ and R⁴ are independently hydrogen, a C₁ to C₁₂ alkyl group, a C₁ to C₁₂ halo alkyl group, a C₃ to C₁₂ cycloalkyl group, a C₃ to C₁₂ heterocycloalkyl group, a C₂ to C₁₂ alkenyl group, a C₂ to C₁₂ haloalkenyl group, a C₆ to C₁₂ aromatic group and a C₆ to C₁₂ heteroaromatic group; R⁵, R⁶ and R⁷ are independently a straight or branched C₁ to C₁₂ alkyl group, R⁸ is hydrogen or methyl, m is 1 to 20 and n is from 1 to 12.

7. The ophthalmic device according to claim 5, wherein in the one or more monofunctional urea-based organosilicon monomers, R is a C₁ to C₆ alkylene group, R¹, R², R³ and R⁴ are independently hydrogen, or a C₁ to C₆ alkyl group; R⁵, R⁶ and R⁷ are independently a straight or branched C₁ to C₆ alkyl group, R⁸ is hydrogen or methyl, m is from 5 to 15, and n is from 1 to 3.

8. The ophthalmic device according to claim 5, wherein in the one or more monofunctional urea-based organosilicon monomers, R is a C₁ to C₆ alkylene group, R¹, R², R³ and R⁴ are independently a C₁ to C₃ alkyl group; R⁵ and R⁶ are independently a C₁ to C₃ alkyl group; R⁷ is a straight or branched C₃ to C₆ alkyl group, R⁸ is hydrogen or methyl, m is from 5 to 15; and n is from 1 to 3.

9. The ophthalmic device according to claim 5, wherein the one or more ophthalmic device-forming hydrophilic comonomers or polymers are selected from the group consisting of an unsaturated carboxylic acid, an acrylamide, a vinyl lactam, a hydroxyl-containing-(meth)acrylate, a hydrophilic vinyl carbonate, a hydrophilic vinyl carbamate, a hydrophilic oxazolone, and a poly(alkene glycol) functionalized with polymerizable groups.

10. The ophthalmic device according to claim 5, wherein the one or more ophthalmic device-forming hydrophilic comonomers or polymers are one or more hydrophilic acrylate or acrylamide comonomers.

11. The ophthalmic device according to claim 10, wherein the one or more hydrophilic acrylate or acrylamide comonomers comprise 2-hydroxyethyl acrylate and dimethylacrylamide.

12. The ophthalmic device according to claim 5, wherein the monomeric mixture comprises:
about 1 wt. % to about 50 wt. %, based on the total weight ofthe monomeric mixture, of the one or more monofunctional urea-based organosilicon monomers; and
about 50 wt. % to about 90 wt. %, based on the total weight of the monomeric mixture, of the one or more ophthalmic device-forming hydrophilic comonomers or polymers.

13. The ophthalmic device according to claim 5, wherein the monomeric mixture further comprises one or more monofunctional urea-based silicone monomers represented by a structure of Formula II: 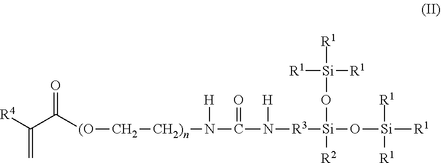
wherein each R¹ is independently an alkyl group; R² is an alkyl group or a trialkyl siloxy group, R³ is an alkylene group, R⁴ is hydrogen or methyl and n is an integer from 1 to 12.

14. The ophthalmic device according to claim 13, wherein R¹ and R² are independently a C₁ to C₆ alkyl group; R³ is a C₁ to C₆ alkylene group; and n is from 1 to 3.

15. The ophthalmic device according to claim 13, wherein R¹ and R² are independently a C₁ to C₃ alkyl group; R³ is a C₁ to C₃ alkylene group; and n is from 3 to 5.

16. The ophthalmic device according to claim 13, wherein R¹ is a C₁ to C₆ alkyl group; R² is a tri C₁ to C₆ alkyl siloxy group, R³ is a C₁ to C₆ alkylene group; and n is from 1 to 3.

17. The ophthalmic device according to claim 13, wherein R¹ is a C₁ to C₃ alkyl group; R² is a tri C₁ to C₃ alkyl siloxy group, R³ is a C₁ to C₃ alkylene group; and n is from 3 to 5.

18. The ophthalmic device according to claim 5, having an equilibrium water content of from about 35 wt. % to about 80 wt. %.

19. The ophthalmic device according to claim 5, which is a silicon hydrogel which is optically clear.

20. A method for making an ophthalmic device, comprising:
(a) curing a monomeric mixture in a mold, the monomeric mixture comprising:
(i) one or more monofunctional urea-based organosilicon monomers represented by a structure of Formula I: 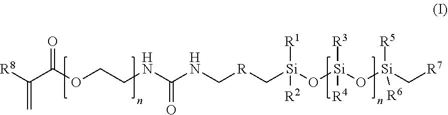
wherein R is an alkylene group; R¹, R², R³ and R⁴ are independently hydrogen, an alkyl group, a halo alkyl group, a cycloalkyl group, a heterocycloalkyl group, an alkenyl group, a haloalkenyl group, an aryl group and a heteroaryl group; R⁵, R⁶ and R⁷ are independently a straight or branched alkyl group; R⁸ is hydrogen or methyl; m is at least 1; and n is at least 1; and
(ii) one or more ophthalmic device-forming hydrophilic comonomers or polymers; and
(b) dry releasing the ophthalmic device from the mold.
